(19) United States
(12) Patent Application Publication
(10) Pub. No.: US 2011/0047240 A1
(43) Pub. Date: Feb. 24, 2011

(54) COMPUTER SYSTEM AND CONTROL METHOD THEREOF

(75) Inventor: Seong-hwan SEOL, Incheon (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/813,722

(22) Filed: Jun. 11, 2010

(30) Foreign Application Priority Data
Aug. 24, 2009 (KR) 10-2009-0077993

(51) Int. Cl. G06F 15/16; G06F 3/048; G06F 3/041

(52) U.S. Cl. 709/208; 715/740; 715/702

(57) ABSTRACT

A computer system and a control method thereof permits utilization of a first or local computer system to access an external computer system more conveniently and can utilize various screens of the computer system more efficiently to access the external computer system. The computer system includes: at least one device unit; a communication unit which communicates with an external computer system; an input unit which receives a user input; and a control unit which controls the device unit to perform an operation based on a first user input which is input through the input unit, and transmits a second user input, which is input through the input unit, to the external computer system through the communication unit to allow the external computer system to be operated based on the second user input.

### CLAIM OF PRIORITY

This application claims priority from Korean Patent Application No. 10-2009-0077993, filed on Aug. 24, 2009 in the Korean Intellectual Property Office, the disclosure of which is incorporated herein by reference.

### BACKGROUND OF INVENTION

1. Field of Invention

The present invention relates to methods and devices for a computer system and a control method thereof. More particularly, the present invention relates to a computer system which accesses external other computer systems, and a control method thereof.

2. Description of the Related Art

In the related art, there has been proposed a ‘remote desktop’ technique that allows a computer system such as a desktop computer or a laptop computer to access different external computer systems (hereinafter referred to as “external computer systems”) (which is hereinafter also called “remote controlling”). With this technique, a user utilizes a local computer system to access the external computer systems connected thereto via a network such as a local area network (LAN).

However, such a conventional technique may have the following problems. First, the computer system has to undergo a remote control setting procedure defined by an operating system or the like of the computer system in order to access the external computer system. However, such a setting procedure may involve a plurality of steps to be performed by a user, such as, for example, an IP setting, which is a troublesome and difficult task to the user, as well as being inconvenient.

Second, with the conventional ‘remote desktop’ technique, a screen of an external computer system has to be displayed on a screen of the local computer system to access the external computer system. In this case, the two screens overlap with each other, with the screen of the external computer system typically covering most or all of the screen of a display of the local computer system, which leads to low screen use efficiency and inconvenience of the user in viewing both screens.

### SUMMARY OF THE INVENTION

Accordingly, it is an aspect of the present invention to provide a computer system that allows a user to access external computer systems more conveniently, and a control method thereof.

Another aspect of the present invention is to provide a computer system that allows the utilization of plural screens to be more efficient than known heretofore when accessing external computer systems.

Additional aspects of the present invention will be set forth in part in the description which follows.

The foregoing and/or other exemplary aspects of the present invention can be achieved by providing a computer system that preferably includes: at least one device unit; a communication unit which communicates with an external computer system; an input unit which receives user input; and a control unit which controls the device unit to perform an operation based on a first user input which is input through the input unit, and transmits a second user input, which is input through the input unit, to the external computer system through the communication unit to allow the external computer system to be operated based on the second user input.

The communication unit may conduct wireless communication, and the control unit may perform a pairing of the computer system according to the present invention which is typically locally attached but might have some peripherals remotely coupled thereto, with the external computer system through the communication unit so that the computer system can be recognized as an input device of the external computer system.

Hereinafter the computer system according to the present invention will be referred to as a “present computer system” to ensure the person of ordinary skill in the art differentiates the present computer system from the external computer system.

The control unit may perform a pairing of the present computer system with the external computer system so that the present computer system can be recognized as a data communication device of the external computer system, and exchanges data with the external computer system.

The present computer system may further include a display unit, and the control unit may remain a screen of the display unit unchanged when the second user input is transmitted to the external computer system.

The present computer system may further include a display unit which displays a cursor corresponding to the user input, and the control unit may control switching between the first user input and the second user input depending on whether the cursor exits or enters a screen of the display unit.

A plurality of external computer systems may be provided, and the control unit may transmit the second user input to an external computer system, which corresponds to a direction in which the cursor exits the screen of the display unit, of the plurality of external computer systems.

The control unit may control a switching between the first user input and the second user input according to a switching instruction input from a user through the input unit.

The foregoing and/or other aspects of the present invention can be achieved by providing a control method of a computer system, including: controlling at least one device unit of a present computer system to perform an operation based on a first user input which is input to the present computer system; and transmitting a second user input, which is input to the present computer system, to an external computer system which communicates with the present computer system to allow the external computer system to be operated based on the second user input.

The control method may further include performing a pairing of the present computer system with the external computer system through wireless communication so that the computer system can be recognized as an input device of the external computer system.

The control method may further include: performing a pairing of the present computer system with the external computer system through wireless communication so that the present computer system can be recognized as a data communication device of the external computer system; and exchanging data with the external computer system.

The present control method may further include keeping a screen of the present computer system unchanged when the second user input is transmitted to the external computer system.

The control method may further include determining whether or not to switch between the first user input and the second user input depending on whether a cursor displayed on a screen of the present computer system corresponding to whether a user input exits or enters the screen of the present computer system.

The transmitting of a second user input may include transmitting the second user input to an external computer system, which corresponds to a direction in which the cursor exits the screen of the computer system, of a plurality of external computer systems.

The control method may further include determining whether to switch between the first user input and the second user input according to a switching instruction input, in which the instruction is input from a user to the present computer system.

As described above, according to an aspect of the invention, a user can utilize the present computer system to access the external computer system more conveniently.

According to an aspect of the invention, a user can use a plurality of screens in the present computer system more efficiently to access the external computer system(s).

### BRIEF DESCRIPTION OF THE DRAWINGS

The above and/or other exemplary aspects of the present invention will become apparent and more readily appreciated from the following description of the exemplary embodiments, taken in conjunction with the accompanying drawings, in which:

FIG. 1 is a view showing a computer system according to an exemplary embodiment of the present invention;

FIG. 2 is a block diagram showing a detailed configuration of the computer system of FIG. 1;

FIG. 3 is a flow chart showing a pairing process of a computer system of the present invention with external computer systems according to an exemplary embodiment of the present invention;

FIG. 4 is a flow chart showing an operating process of a computer system according to an exemplary embodiment of the present invention;

FIGS. 5 and 6 are a flow chart and a reference view showing inputs by a computer system user and its associated operation, respectively, according to an exemplary embodiment of the present invention; and

FIG. 7 is a reference view for explaining a computer system according to another exemplary embodiment of the present invention.

### DETAILED DESCRIPTION

Reference will now be made in detail to the exemplary embodiments of the present invention, some examples of which are illustrated in the accompanying drawings, so that a person of ordinary skill in the art can practice the present invention without undue experimentation. The present invention is not limited to exemplary embodiments disclosed herein but may be implemented in different forms that are within the spirit of the invention and the scope of the appended claims.

In the following exemplary embodiments, for the purpose of clarity, the same components are denoted by the same reference numerals throughout the drawings, and explanation thereof will be representatively given in a first exemplary embodiment but will be omitted in other exemplary embodiments.

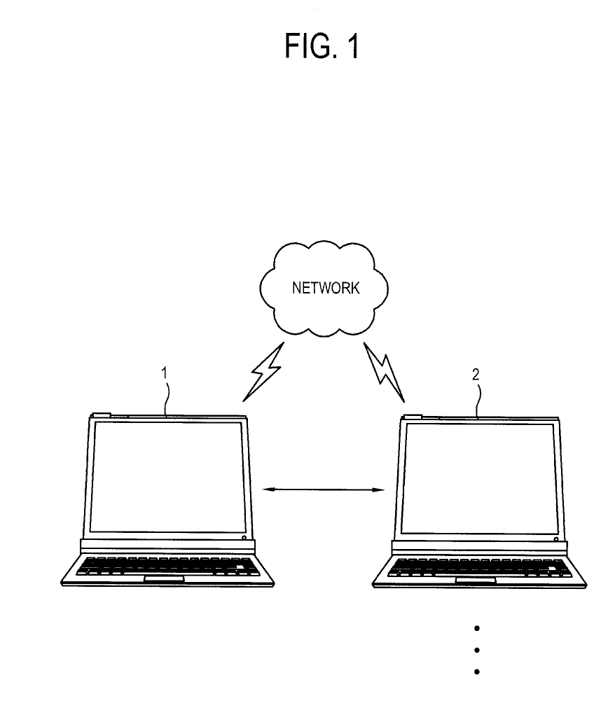

FIG. 1 shows a computer system according to an exemplary embodiment of the present invention. A present computer system 1 shown in FIG. 1 may be implemented by a common personal computer (PC), such as a desktop computer, a laptop computer, a tablet computer, a netbook, a PDA, a mobile terminal with processing capability, etc., or any other type of apparatus having the same function and/or function similar to PC. The present computer system 1 can be connected to one or more external computer systems 2 9 to allow a user to access the external computer systems 2. Like the present computer system 1, the external computer systems 2 may be also implemented by any type of apparatus, including but in no way limited to a desktop computer, a laptop computer, a tablet computer, a netbook, a PDA, a mobile terminal with processing capability, etc. The computer system 1 may be connected to more than a single external computer system 2, but also may be connected to a plurality of external computer systems 2 either simultaneously or sequentially, for example.

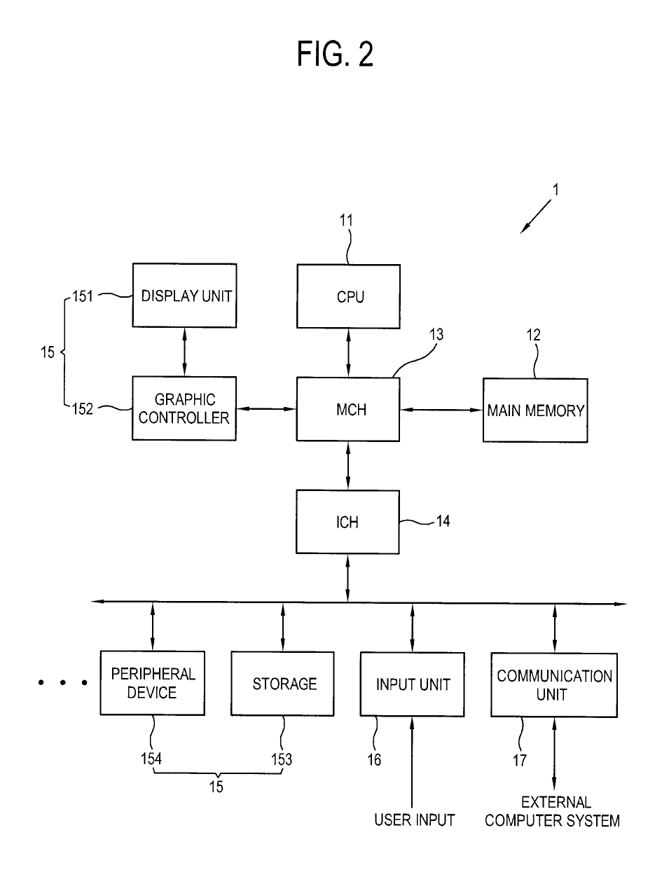

FIG. 2 is a block diagram showing a detailed configuration of the computer system 1 of FIG. 1. As shown in the example of FIG. 2, the computer system 1 may include a central processing unit (CPU) 11, a main memory 12, a memory controller hub (MCH) 13, an I/O controller hub (ICH) 14 and a device part 15.

The CPU 11 preferably controls the entire operation of the present computer system 1 and executes a computer program containing executable code that is stored on machine readable data loaded into the main memory 12. In executing the computer program, the CPU 11 can communicate with and control the MCH 13, the ICH 14 and the device part 15.

The main memory 12 temporarily stores data related to operational performance of the CPU 11 including the computer program to be executed by the CPU 11. The main memory 12 may be implemented by a volatile memory such as a double-data-rate synchronous dynamic random access memory (DDR SDRAM) or the like.

The device part 15 may include various kinds of hardware, for example, a display unit 151, a graphic controller 152, a storage 153 and a peripheral device 154, just to name a few possibilities. The graphic controller 152 processes graphic data and the display unit 151 displays an image based on the graphic data processed by the graphic controller 152. The display unit 151 may be implemented by a liquid crystal display (LCD), an organic light-emitting diode (OLED) or the like. The storage 153 may be implemented by a nonvolatile memory which stores data, such as a hard disc drive, a compact disc ROM (CD-ROM), a digital versatile disc ROM (DVD-ROM) or the like. In addition, the peripheral device 154 may include, for example, a universal serial bus (USB) drive, a modem, a network card, a sound card, a speaker, a microphone and so on.

With continued reference to FIG. 2, the MCH 13 interfaces data read and written between various components such as the CPU 11 and so on and the main memory 12. The ICH 14 interfaces communication between the CPU 11 and the device part 15.

In this exemplary embodiment, a combination of the CPU 11, the main memory 12, the MCH 13 and the ICH 14 is merely one example of a control unit. In the following description, a reference numeral for the control unit will be omitted for the sake of convenience.

In this exemplary embodiment, the controller may further include a basic input/output system (BIOS), an operating system (OS), and applications of the computer system 1.

In this exemplary embodiment, the BIOS may be stored in a BIOS ROM (not shown), which is a nonvolatile memory, and the OS and the applications may be stored in the storage 153 such as a hard disk drive.

The computer system 1 further includes an input unit 16 which receives inputs from a user, and a communication unit 17 which communicates with the external computer systems 2 (FIG. 1). Examples of the input unit 16 may include a keyboard, a mouse, a tablet, a microphone, a touch screen and the like.

The form of communication conducted by the communication unit 17 may include wireless communication. In this exemplary embodiment, the wireless communication may include local area network (LAN) wireless communication such as Bluetooth, a wireless USB or the like. The communication unit 17 may include hardware such as a Bluetooth adaptor with a corresponding communication function to conduct communication according to a corresponding protocol such as Bluetooth. In addition, the communication unit 17 may further include a driver which is software for interface between the hardware such as the Bluetooth adaptor and the OS of the computer system 1. As an alternative exemplary embodiment, a driver of the hardware such as the Bluetooth adaptor may be incorporated into the OS of the computer system 1.

In this exemplary embodiment, the control unit controls the device part 15 to perform its operation based on a first input of the user through the input unit 16 and transmits a second input of the user through the input unit 16 to the external computer systems 2 via the communication unit 17, so that the external computer systems can be operated based on the second input of the user. Here, the user's first input corresponds to a typical input to allow the user to use the computer system 1. On the other hand, the external computer systems 2 perform their corresponding operations based on the user's second input transmitted from the computer system 1. In this case, the computer system 1 performs a function as an input device of the external computer systems 2.

Accordingly, in this exemplary embodiment, by distinguishing between user inputs which are input through the input unit 16 of the computer system 1 and selectively accessing external computer systems 2, it is possible to not only use the computer system 1 but also allow the computer system 1 to access the external computer systems 2 with only a simple configuration of the computer system 1 without intervention of other separate devices. Accordingly, the user can use the computer system 1 to access the external computer system 2 more conveniently.

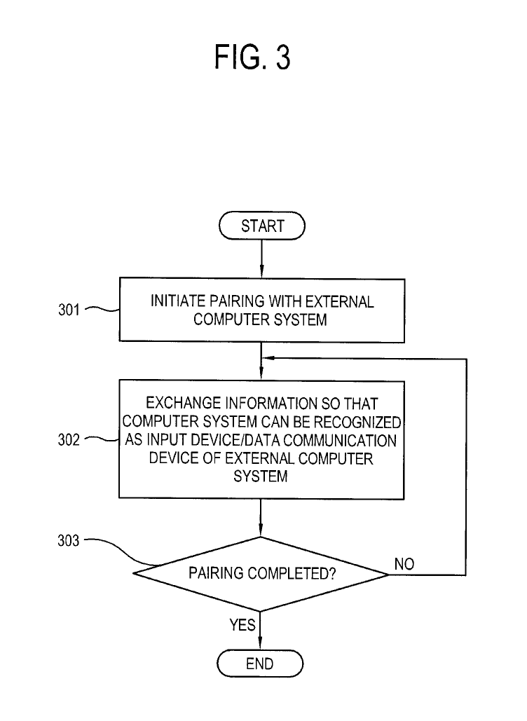

In one exemplary embodiment, a pairing process of the computer system 1 with the external computer systems 2 may precede the access to the external computer system 2. Hereinafter, the pairing process of the computer system 1 with the external computer systems 2 will be described in detail with reference to FIG. 3.

FIG. 3 is a flow chart showing the pairing process of the computer system 1 along with the external computer systems 2 according to one exemplary embodiment of the present invention.

First, in this exemplary embodiment, at step (301), the control unit initiates a pairing process of the computer system 1 with the external computer systems 2 according to a request from a user or when predetermined conditions come. In this exemplary embodiment, the predetermined conditions may include, for example, a turn-on of the computer system 1, a wake-up to a normal mode from a standby mode for power saving, and a periodical performance according to a predetermined unit of time.

In this exemplary embodiment, the pairing process of the computer system 1 with the external computer systems 2 may be performed by mutually recognizing the computer system 1 and the external computer systems 2 and storing their identification information as a premise for mutual communication between the computer system 1 and the external computer systems 2. After the pairing process is performed, the computer system 1 and the external computer systems 2 can conduct mutual communication by referring to their stored identification information.

In this exemplary embodiment, at step (302), the control unit of the computer system 1 exchanges related information with the external computer systems 2 through the communication unit 17 so that the computer system 1 can be recognized as an input device of the external computer systems 2. The input device recognized by the external computer systems 2 corresponds to the type of particular input devices included in the input unit 16 of the computer system 1. For example, if the input unit 16 includes a keyboard and a mouse, the external computer systems 2 can recognize the computer system 1 as a keyboard and a mouse. It the displays are touch screens, one can move a finger on or near the screen to indicate or control cursor motion and/or selection of a particular computer system, external or otherwise. The type of particular input devices included in the input unit 16 is not limited thereto and the pairing process may be performed for all or some of a plurality of input devices included in the input unit 16.

In the operation at step (302), the exchange of the related information is performed according to a communication protocol corresponding to functionality of the communication unit 17. As illustrated earlier, the communication protocol of this exemplary embodiment include Bluetooth as one example of LAN wireless communication protocols. In addition, in one exemplary embodiment, the pairing process may include an authentication step. Of course, the person of ordinary skill in the art understands and appreciates that any other type of wireless communication protocol could be used, and the invention is in no way limited to using Bluetooth.

In an additional exemplary embodiment, in the operational step (302), the control unit of the computer system 1 may exchange related information with the external computer systems 2 so that the computer system 1 can be further recognized as a data communication device of the external computer systems 2. Accordingly, the computer system 1 may exchange predetermined data with the external computer systems 2 while performing data communication with the external computer systems 2.

Next, at step (303), the control unit determines whether or not the pairing process of the computer system 1 with the external computer systems 2 has been completed. If it is determined that the pairing process has not been completed, then step (302) is repeated. Otherwise, the process ends.

As described above, according to this exemplary embodiment, the pairing process of the computer system 1 with the external computer systems 2 based on a LAN wireless communication protocol that allows the user to access the external computer systems 2 conveniently without having to take conventional troublesome setting steps such as remote control setting for access to the external computer systems 2.

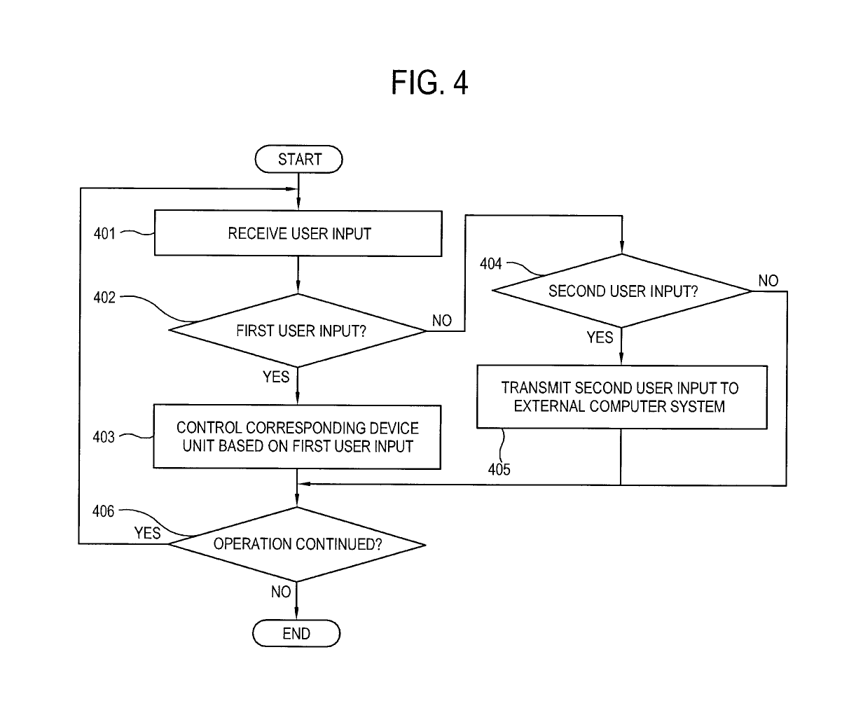

Hereinafter, an operating process of the computer system 1 according to an exemplary embodiment of the present invention will now be described in more detail with reference to FIG. 4.

FIG. 4 is a flow chart showing an operating process of the computer system 1 according to an exemplary embodiment of the present invention. First, at step (401), the computer system 1 receives a user input through the input unit 16.

Next, at step (402), the control unit of the computer system 1 determines whether or not the received input is a first user input. If it is determined in the operation 402 that the received input is the first user input, then at step (403) the control unit controls the device unit 15 corresponding to the first user input.

On the other hand, at step (402), if it is determined that the received input is not the first user input, then at step (404) the control unit determines whether or not the received input is a second user input. A person of ordinary skill in the art should understand that the first user input and the second user input could be the same user trying to access a different (e.g. external) computer.

If it is determined in the operation 404 that the received input is the second user input, then at step (405) the control unit transmits the second user input to the external computer systems 2 through the corresponding communication unit 17. In step (405), the control unit controls the communication unit 17 such that the computer system 1 can act as an input device of the external computer systems 2.

On the other hand, after steps (403) or (405), or if it is determined at step (404) that the received input is not the second user input, then at step (406) control unit determines whether to repeat the process. If it is determined that the process is repeated, steps (401) and the later operations are repeated. Otherwise, the process is ended.

As an alternative exemplary embodiment, when the control unit transmits the second user input to the external computer systems 2 at step (405), the contents of a screen of the display unit 151 may remain unchanged. In other words, in this exemplary embodiment, even when the computer system 1 acts as an input device of the external computer systems 2, since the screen of the display unit 151 of the computer system 1 can remain unchanged without the computer system 1 being affected by the operation of the external computer systems 2, the user can use both screens of the computer system 1 and the external computer systems 2 efficiently. In other exemplary embodiments, the operation 402 and the operation 404 may be performed in a reversed order.

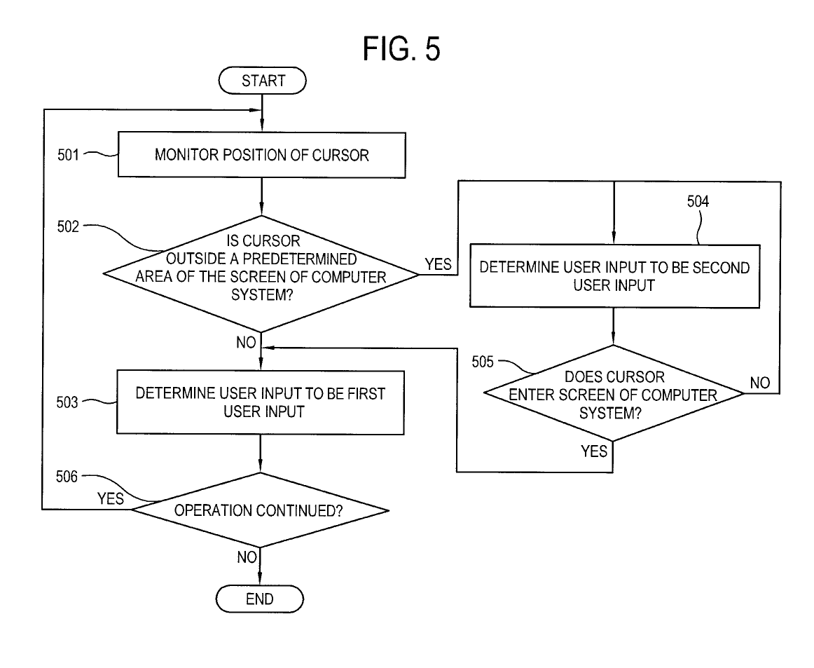

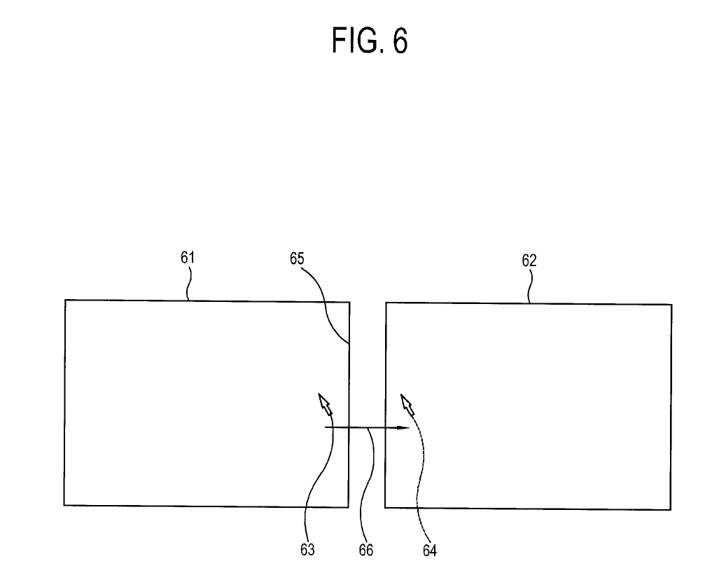

Hereinafter, according to an exemplary embodiment of the present invention, the distinguishment between inputs by the user of the computer system 1 and its associated operation will be described in more detail with reference to FIGS. 5 and 6. FIGS. 5 and 6 are a flow chart and a reference view showing the distinguishment between inputs by the user of the computer system 1 and its associated operation, respectively, according to an exemplary embodiment of the present invention.

In FIG. 6, reference numerals 61 and 62 denote respective screens of the computer system 1 and a screen of an external computer system 2. In this exemplary embodiment, it is assumed that the computer system 1 and the external computer system 2 are arranged close to each other enough to allow a user to view both of these screens 61 and 62, such as in a side by side arrangement. In addition, in this exemplary embodiment, the input unit 16 includes a mouse, and reference numerals 63 and 64 denote a mouse cursor (hereinafter abbreviated as “cursor”) displayed on the screen 61 of the computer system 1 and screen 62 of the external computer system 2, respectively.

In this exemplary embodiment shown in FIG. 6, it is assumed that the cursor 63 is currently located on the screen 61 of the computer system 1 and the cursor 63 is being moved by manipulation of the user.

Referring to FIGS. 5 and 6, in this embodiment, first, at step (501) the control unit monitors a position of the cursor 63 on the screen 61 of the computer system 1.

Subsequently, at step (502), the control unit checks whether or not the cursor 63 is outside of a predetermined area of the screen 61 of the computer system 1. In this exemplary embodiment, in the operation 502, the control unit may determine whether or not the cursor 63 is outside of predetermined area of the screen 61 of the computer system 1 depending on whether or not a coordinate of the cursor 63 in a horizontal direction 66 is outside a right edge 65 of the screen 61 of the computer system 1. Alternatively the control unit can determined whether the cursor is outside of a particular portion of the viewing area, or not visible because of the cursor's present position outside of a particular portion of the screen constitutes, for example, that the cursor is “outside of” or having “exited” the viewable area of the screen 61.

If it is determined at step (502) that the cursor 63 is not outside of a predetermined area of the screen 61 of the computer system 1, then at step (503) the control unit determines that a user input is a first user input. In this case, the control unit controls the corresponding device unit 15 based on the first user input, as described with reference to FIG. 4.

On the other hand, if it is determined in the operation 502 that the cursor 63 is outside of a predetermined area of the screen 61 of the computer system 1, then at step (504), the control unit determines that a user input is a second user input. In this case, the control unit determines that the computer system 1 acts as an input device of the external computer system 2 and transmits the second user input to the external computer system 2, as described with reference to FIG. 4.

Accordingly, referring again to FIG. 6, the external computer system 2 displays the cursor 64 at a predetermined position on the screen 62 based on the second user input received from the computer system 1 which acts as an input device (a mouse in this embodiment) of the external computer system 2. Then, a user input received through the input unit 16 of the computer system 1 can be transmitted to the external computer system 2, thereby allowing the user to utilize the computer system 1 to access the external computer system 2.

After it is determined at step (504) that the user input through the input unit 16 is the second user input, then at step (505) the control unit checks whether or not the cursor 64 enters the screen 61 of the computer system 1. In this exemplary embodiment, in the operation 505, the control unit may detect the position of the cursor 64 by monitoring the second user input transmitted to the external computer system 2. For example, the control unit may determine whether or not the cursor 64 enters the screen 61 of the computer system 1 depending on whether or not a coordinate of the cursor 64 in the horizontal direction 66 is inside the right edge 65 of the screen 61 of the computer system 1.

If it is determined step (505) that the cursor 64 does not enter the screen 61 of the computer system 1, then at step (504) the control unit determines that the user input is the second user input. On the other hand, if it is determined that the cursor 64 enters the screen 61 of the computer system 1, at step (503) the control unit determines that the user input is the first user input and controls the corresponding device unit 15 of the computer system 1 based on the first user input, as described earlier.

Next, at step (506), the control unit checks whether to repeat the process. If it is determined that the process is to be repeated, the operation 501 and the later operations are repeated. Otherwise, the process ends.

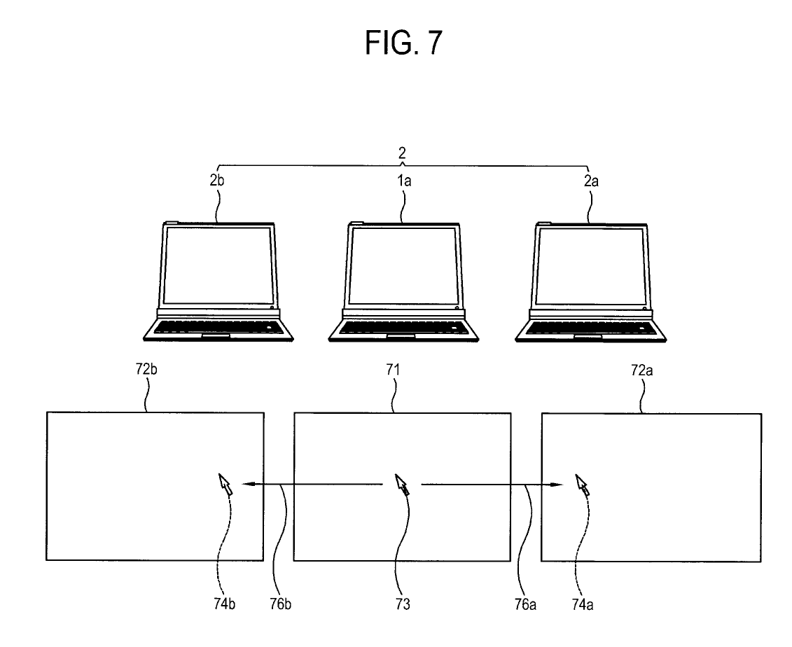

FIG. 7 is a reference view for explaining a computer system 1a according to another exemplary embodiment of the present invention. In the computer system 1a shown in FIG. 7, an explanation of the same components as or components similar to the computer system 1 shown in FIGS. 1 to 6 will be omitted.

As shown in FIG. 7, an external computer system 2 includes two external computer systems 2a and 2b. The two external computer systems 2a and 2b are arranged on the right and left sides of the computer system 1a, respectively. In this figure, reference numerals 71, 72a and 72b denote screens of the computer system 1a and the two external computer systems 2a and 2b, respectively, and reference numerals 73, 74a and 74b denote a cursor displayed on the screen 71 of the computer system 1a and cursors displayed on the screens 72a and 72b of the two external computer systems 2a and 2b.

In this exemplary embodiment, a control unit of the computer system 1a determines whether the second user input is to be transmitted to one of the two external computer systems 2a and 2b in consideration of arrangement of the external computer systems 2a and 2b with respect to the computer system 1a. Information on the arrangement of the external computer systems 2a and 2b may be pre-stored in the computer system 1a.

As shown in FIG. 7, in this exemplary embodiment, while monitoring a position of the cursor 73 on the screen of the computer system 1a, the control unit may determine the external computer system 2a and 2b to which the second user input is to be transmitted depending on a direction in which the cursor 73 is get out of the screen 71. For example, if the cursor 73 exits (i.e. is outside of a predetermined area of) the screen 71 of the computer system 1a in the rightward direction 76a, the control unit transmits the second user input to the external computer system 2a. On the other hand, if the cursor 73 exits (i.e. is outside of a predetermined area of) the screen 71 of the computer system 1a in the leftward direction 76b, then the control unit transmits the second user input to the external computer system 2b.

The number and arrangement of external computer systems are not limited to the exemplary embodiment shown in FIG. 7 but may be implemented in various ways. For example, although not shown, external computer systems may be arranged in the front or rear of the computer system. In this case, the control unit of the computer system may determine the external computer systems to which the second user input is to be transmitted depending on whether the cursor exited the screen of the computer system upward or downward.

In addition, the distinguishment between user inputs of the computer system is not limited to the exemplary embodiment described with reference to FIGS. 5 to 7. For example, in response to a predetermined input received through the input unit 16, for example, in response to right double click of a mouse or pushing of any key of a keyboard (for example “F1” could indicate a first computer system, “F2” a first external computer on the left, etc., it may be determined that a switching between the first user input and the second user input is made. It is also possible to move the mouse in a certain direction one or more times in a pattern gesture to indicate a particular external computer system.

Hereinafter, a computer system according to still another exemplary embodiment of the present invention will be described. In the computer system of this exemplary embodiment, explanation of the same components as or components similar to the computer systems 1 and 1a shown in FIGS. 1 to 7 will be omitted. In this embodiment, a control unit of the computer system exchanges related information with external computer systems so that the computer systems can be recognized as an input device and a data communication device of the external computer systems when the computer system is paired with the external computer systems.

In this exemplary embodiment, the control unit transmits a second user input, which is input through an input unit of the computer system as the input device, to the external computer systems and transmits predetermined data to the external computer systems by communicating with the external computer systems through a communication unit as the data communication device. In this exemplary embodiment, the data transmitted from the computer system to the external computer systems are not particularly limited. For example, the data may include data requested by any of the computer systems and the external computer system.

For example, it is assumed that a user moves a cursor from the screen of the computer system to a screen of one of the external computer systems while clicking on and dragging a predetermined file icon displayed on the screen of the computer system. In this case, the control unit decides this operation to be an instruction to copy the clicked file into the external computer system and transmits data of the file to the external computer system through the communication unit. At this time, the control unit controls the communication unit such that the computer system can correspondingly act as the input device and the data communication device of the external computer system.

The data exchange between the computer system and the external computer systems in this exemplary embodiment is merely one example but the invention is not limited thereto.

In this manner, according to this exemplary embodiment, since the computer system can act as the input device and the data communication device of the external computer systems, the user can use the computer system and the external computer systems more conveniently in various manners.

Finally, a person of ordinary skill in the art should also understand and appreciate that while separate displays are being shown in the examples, the present invention would also be applicable in subdivisions of a single screen that is logically partitioned into displays of more than one computer system, or operating system.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer system comprising:
a first computer system having at least one device unit;
a communication unit for communicating with a second computer system comprising an external computer system;
an input unit for receiving a user input; and
a control unit for controlling the device unit to perform an operation based on an input that is determined to be a first user input that is input through the input unit, and transmits another input, which is determined to be a second user input through the input unit, to the external computer system through the communication unit to control operation of the external computer system to be operated based on the second user input.

2. The computer system according to claim 1, wherein the communication unit performs wireless communication with the external computer system, and
wherein the control unit performs a pairing of the first computer system with the external computer system through the communication unit so that the computer system is recognized as an input device of the external computer system.

3. The computer system according to claim 2, wherein the control unit performs a pairing of the first computer system with the external computer system so that the computer system is recognized as a data communication device of the external computer system, and exchanges data with the external computer system.

4. The computer system according to claim 1, further comprising a display unit,
wherein the control unit does not change a screen of the display unit when the second user input is transmitted to the external computer system.

5. The computer system according to claim 2, further comprising a display unit,
wherein the control unit does not change a screen of the display unit when the second user input is transmitted to the external computer system.

6. The computer system according to claim 1, further comprising a display unit which displays a cursor corresponding to the user input,
wherein the control unit controls switching between the first user input and the second user input depending on a position of the cursor on a screen of the display unit.

7. The computer system according to claim 6, wherein the screen comprises a touch screen and the cursor is moved by the touch screen sensing movement of a finger or stylus.

8. The computer system according to claim 6, wherein the cursor exits or enters a respective predetermined portion of the screen for indicating a first user input or a second user input.

9. The computer system according to claim 8, wherein the predetermined portion comprises one of a particular viewable portion or non-viewable portion of the screen.

10. The computer system according to claim 2, further comprising a display unit which displays a cursor corresponding to the user input,
wherein the control unit controls switching between the first user input and the second user input depending on whether the cursor exits or enters a screen of the display unit.

11. The computer system according to claim 6, wherein a plurality of external computer systems is provided, and
wherein the control unit transmits the second user input to an external computer system that corresponds to a direction in which the cursor exits the screen of the display unit, of the plurality of external computer systems.

12. The computer system according to claim 10, wherein a plurality of external computer systems is provided, and
wherein the control unit transmits the second user input to the external computer system that corresponds to a direction in which the cursor exits the screen of the display unit, of the plurality of external computer systems.

13. The computer system according to claim 1 wherein the control unit controls a switching operation between the first user input and the second user input according to a switching instruction input from a user through the input unit that determines whether a user input is a first user input or a second user input.

14. The computer system according to claim 2, wherein the control unit controls a switching operation between the first user input and the second user input according to a switching instruction input from a user through the input unit.

15. A control method of a computer system, comprising:
controlling at least one device unit of a first computer system to perform an operation based on a first user input which is input to the first computer system; and
transmitting a second user input, which is input to the first computer system, to a second computer system comprising an external computer system that communicates with the first computer system to allow the external computer system to operate based on the second user input.

16. The control method according to claim 15, further comprising performing a pairing of the computer system with the external computer system through wireless communication so that the first computer system is recognized as an input device of the external computer system.

17. The control method according to claim 16, further comprising:
performing a pairing of the first computer system with the external computer system through wireless communication so that the first computer system is recognized as a data communication device of the external computer system; and
exchanging data with the external computer system.

18. The control method according to claim 15, further comprising keeping a screen of the first computer system unchanged when the second user input is transmitted to the external computer system.

19. The control method according to claim 16, further comprising keeping a screen of the first computer system unchanged when the second user input is transmitted to the external computer system.

20. The control method according to claim 15, further comprising determining whether or not to perform a switching operation between the first user input and the second user input depending on whether a cursor displayed on a screen of the first computer system corresponding to a user input exits or enters the screen of the first computer system.

21. The control method according to claim 16, further comprising determining whether to perform a switching operation between the first user input and the second user input depending on whether a cursor displayed on a screen of the computer system corresponding to a user input exits or enters the screen of the first computer system.

22. The control method according to claim 21, wherein the cursor is determined as being the first user input when arranged at a predetermined area of the screen and a second user input when arranged outside of the predetermined area of the screen.

23. The control method according to claim 20, wherein the external computer systems comprises a plurality of computer systems, and wherein transmitting a second user input includes transmitting the second user input to the external computer system, which corresponds to a direction in which the cursor exits the screen of a particular computer system of the plurality of external computer systems.

24. The control method according to claim 16, further comprising determining whether to perform a switching operation between the first user input and the second user input according to a switching instruction input which is input from a user to the computer system.
